(19) United States
(12) Patent Application Publication
(10) Pub. No.: US 2013/0242563 A1
(43) Pub. Date: Sep. 19, 2013

(54) HEAT DISSIPATING DEVICE FOR LAMPS

(71) Applicant: CHAO-CHUAN CHEN, TAICHUNG CITY (TW)

(72) Inventor: CHAO-CHUAN CHEN, TAICHUNG CITY (TW)

(21) Appl. No.: 13/424,339

(22) Filed: Mar. 19, 2012

(51) Int. Cl. F21V 29/00

(52) U.S. Cl. 362/294

(57) ABSTRACT

A heat dissipating device for lamps includes a heat dissipating cover. The top side of the heat dissipating cover has a first opening defined thereon. The bottom side of the heat dissipating cover has a second opening defined thereon. The diameter of the first opening is smaller than the diameter of the second opening. An annular recess with a base is formed between the first opening and second opening. A light source is assembled to the base of the annular recess. A glass shade covers the light source. Thus, the heat from the light source is dissipated into the air quickly because of the heat dissipating cover and the glass shade both with high thermal conductivity. The heat is not influenced on the light source for a long term use.

### BACKGROUND OF THE INVENTION

1. Field of the Invention

The present invention relates to a heat dissipating device, more particularly to a heat dissipating device for lamps.

2. Description of Related Art

With the development of high efficiency and high power LEDs, it has become possible to use LEDs in lighting and illumination. Replacement light bulbs have been made, as well as dedicated fixtures and LED lamps. LEDs are used as street lights and in other architectural lighting where color changing is used. However, light emitting efficiency of the LED lamp is easily affected by heat, particularly under high power of the electric current for a long time, the color performance becomes unstable. In addition, most of the electrical elements are damaged easily in the high temperature environment. How to design an efficient heat sink for the LED lamp becomes an important issue in this field.

The conventional heat dissipating devices are using several thermal conducting fins 5 which are placed around a transparent portion 6 of the lamp. The thermal conducting fins 5 are radially aligned on the lamp, such that the heat can be conducted to the thermal conducting fins 5 and dissipated into the air. The thermal conducting fins 5 provide a lot of contacting area between the lamp and the air, and each of thermal conducting fins 5 is made from materials with high thermal conductivity, such as copper, aluminum, and aluminum-alloys. Thus, the heat is dissipated into the air quickly via the thermal conducting fins 5. The thermal conducting fins 5 can be further bent for increasing contacting area between the lamp and the air.

Unfortunately, the cost of the copper, aluminum, and aluminum-alloys becomes so expensive day after day that the thermal conducting fins 5 become more expensive to be manufactured. In addition, each of the thermal conducting fins 5 has its own thickness, such that the amount of the thermal conducting fins 5 and thickness does not allow the contacting area to increase infinitely on the lamp. Finally, to produce one bending thermal conducting fin 5 with rigid structure is not easy on the assembly line.

The present invention has arisen to mitigate and/or obviate the disadvantages of the conventional.

### SUMMARY OF THE INVENTION

The main objective of the present invention is to provide an improved heat dissipating device for lamps.

To achieve the objective, a heat dissipating device for lamps comprises a heat dissipating cover, the top side of the heat dissipating cover having a first opening defined thereon, the bottom side of the heat dissipating cover having a second opening defined thereon, the diameter of the first opening smaller than the diameter of the second opening, an annular recess with a base formed between the first opening and second opening, a light source assembled to the base of the annular recess, a glass shade assembled to the second opening, the glass shade covering the light source; thereby the heat from the light source is dissipated into the air quickly because of the heat dissipating cover and the glass shade both with high thermal conductivity; the heat is not influenced on the light source for a long term use.

The heat dissipating cover comprises at least one first vent and at least one second vent defined on the peripheral of the heat dissipating cover, the first vent close to the first opening, the second vent close to the second opening.

The heat dissipating cover comprises at least one first vent or at least one second vent defined on the peripheral of the heat dissipating cover.

The base of the annular recess has at least one third vent defined thereon. The third vent is near the light source.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a heat dissipating device for lamps in accordance with the present invention;

FIG. 2 is a cross-sectional view of the heat dissipating device for lamps in accordance with the present invention;

FIG. 3 is a perspective view of the heat dissipating device for lamps with a power member;

FIG. 4 is an exploded view of a heat dissipating device for lamps with two first, second, and third vents;

FIG. 5 is an exploded view of a heat dissipating device for lamps with eight first, second, and third vents;

FIG. 6 is a cross-sectional view of FIG. 4; and

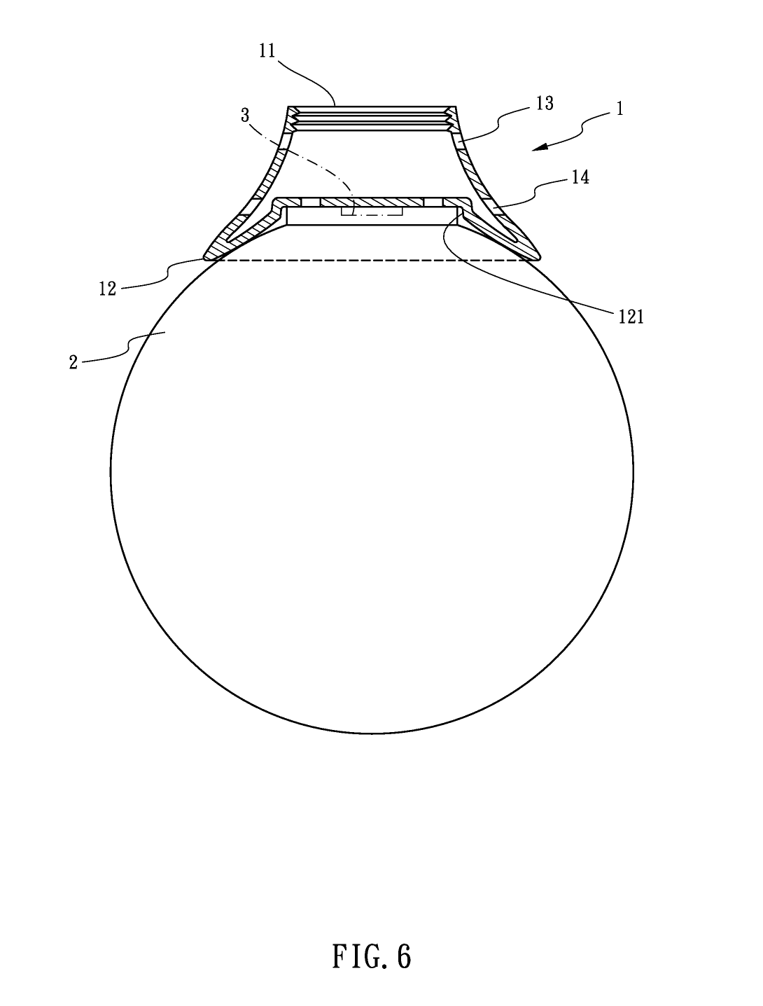

FIG. 7 is a perspective view of the prior art.

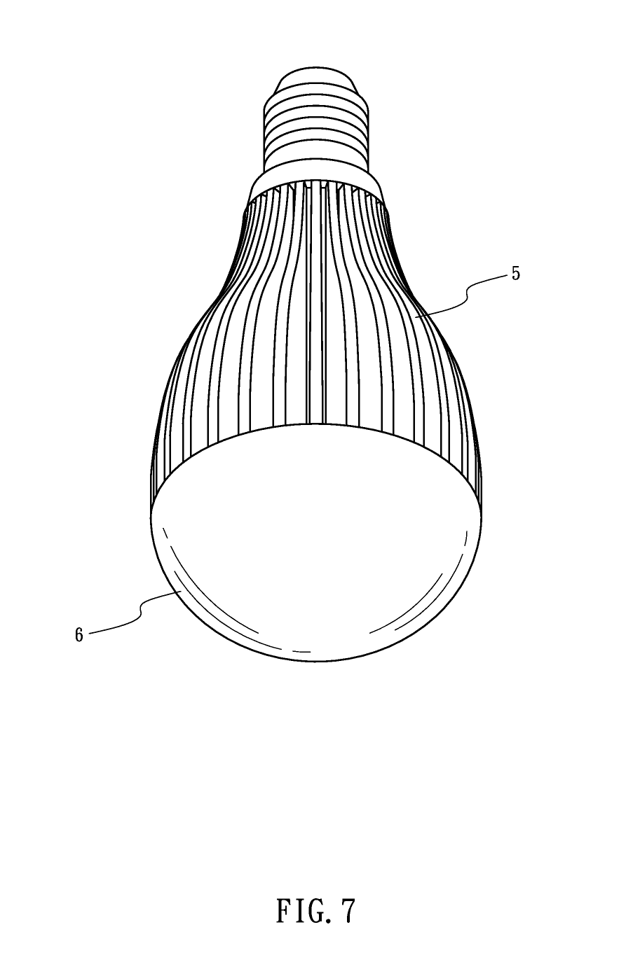

### DETAILED DESCRIPTION OF THE INVENTION

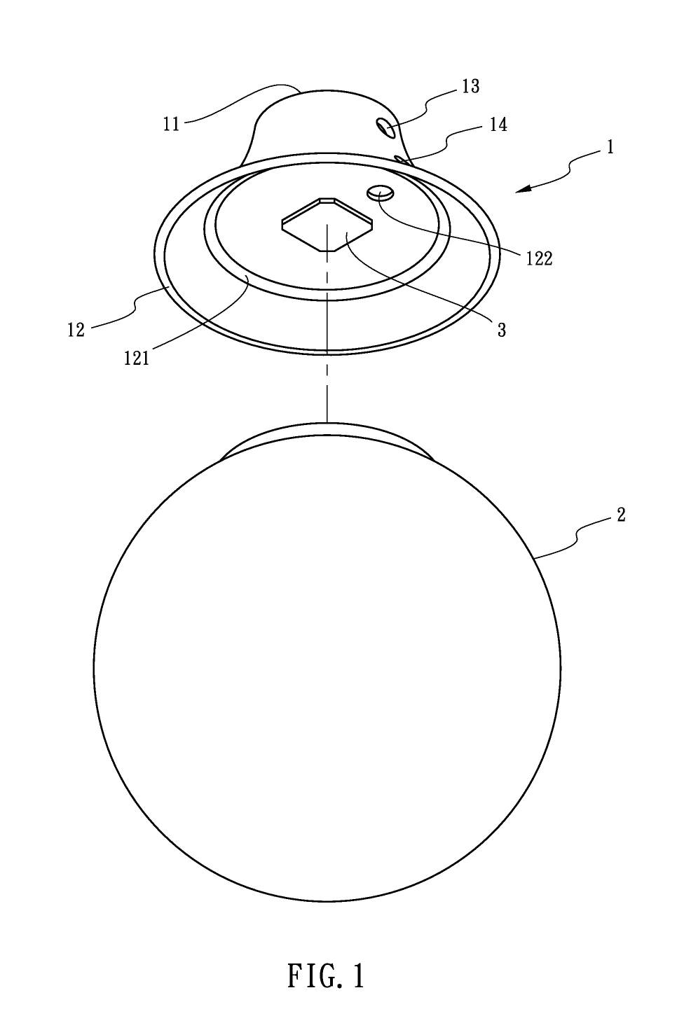

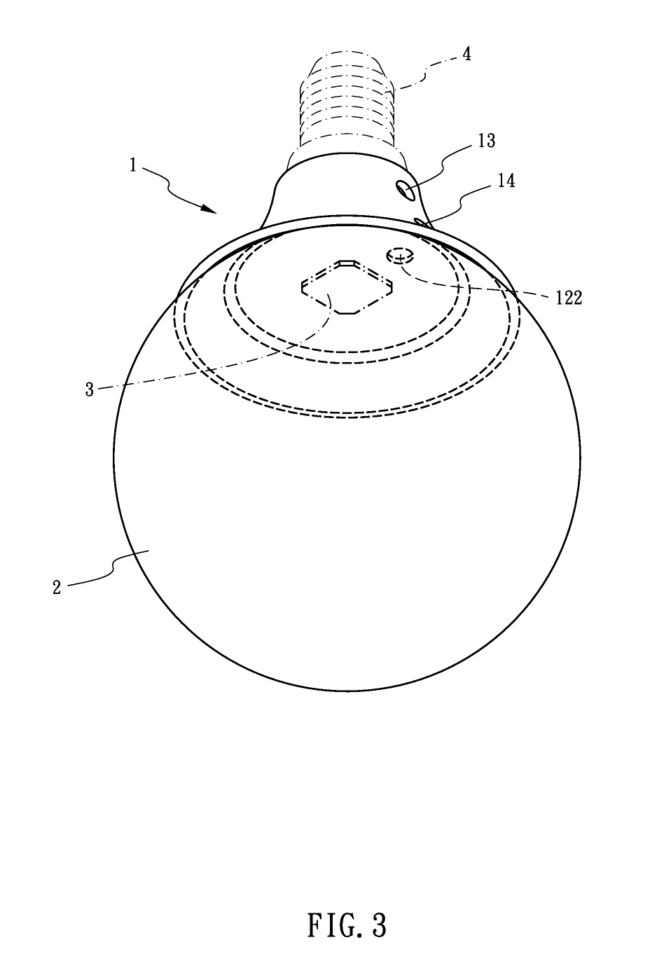

Referring to FIGS. 1-3, a heat dissipating device for lamps in accordance with the present invention comprises a heat dissipating cover 1 and a glass shade 2. The heat dissipating cover 1 is made from materials with high thermal conductivity, such as copper, aluminum, and aluminum-alloys. The shape of the heat dissipating cover 1 is much similar to flowerpots. The top side of the heat dissipating cover 1 has a first opening 11 defined thereon. The bottom side of the heat dissipating cover 1 has a second opening 12 defined thereon. The diameter of the first opening 11 is smaller than the diameter of the second opening 12. An annular recess 121 with a base is formed between the first opening 11 and second opening 12. A light source 3 is assembled to the base of the annular recess 121.

The glass shade 2 is assembled to the second opening 12. The glass shade 2 is made from transparent materials with high thermal conductivity, such as glass. The glass shade 2 covers the light source 3. The light source 3 is a light emitting diode. The light beams from the light source 3 are emitting out of the glass shade 2 for illuminating outsides. A power member 4 is assembled to the first opening 11. The light source 3 is electrically connected to the power member 4.

Under this arrangement, the heat from the light source 3 is dissipated into the air quickly because of the heat dissipating cover 1 and the glass shade 2 both with high thermal conductivity. The heat is not influenced on the light source 3 for a long term use.

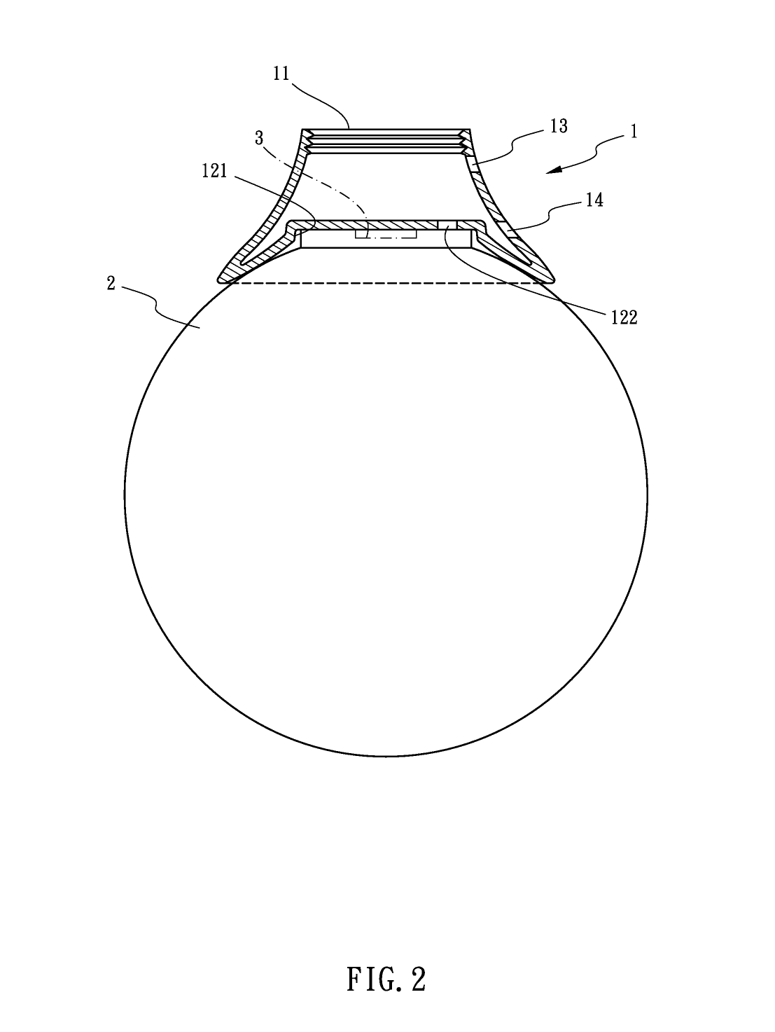

Referring to FIGS. 1-2, the heat dissipating cover 1 further comprises at least one first vent 13 and at least one second vent 14 . defined on the peripheral of the heat dissipating cover 1. The first vent 13 is close to the first opening 11. The second vent 14 is close to the second opening 12. The first vent 13 and the second vent 14 are vertically aligned on the peripheral of the heat dissipating cover 1. In addition, the base of the annular recess 121 has at least one third vent 122 defined thereon. The third vent 122 is near the light source 3. According to the location of first vent 13, second vent 14, and the third vent 122, the heat air from the light source 3 is upwardly flowing into the third vent 122 and dissipating into the air via first vent 13, and the cool air from outsides are flowing into the heat dissipating cover 1 and glass shade 2 via second vent 14 to finish the thermal convection.

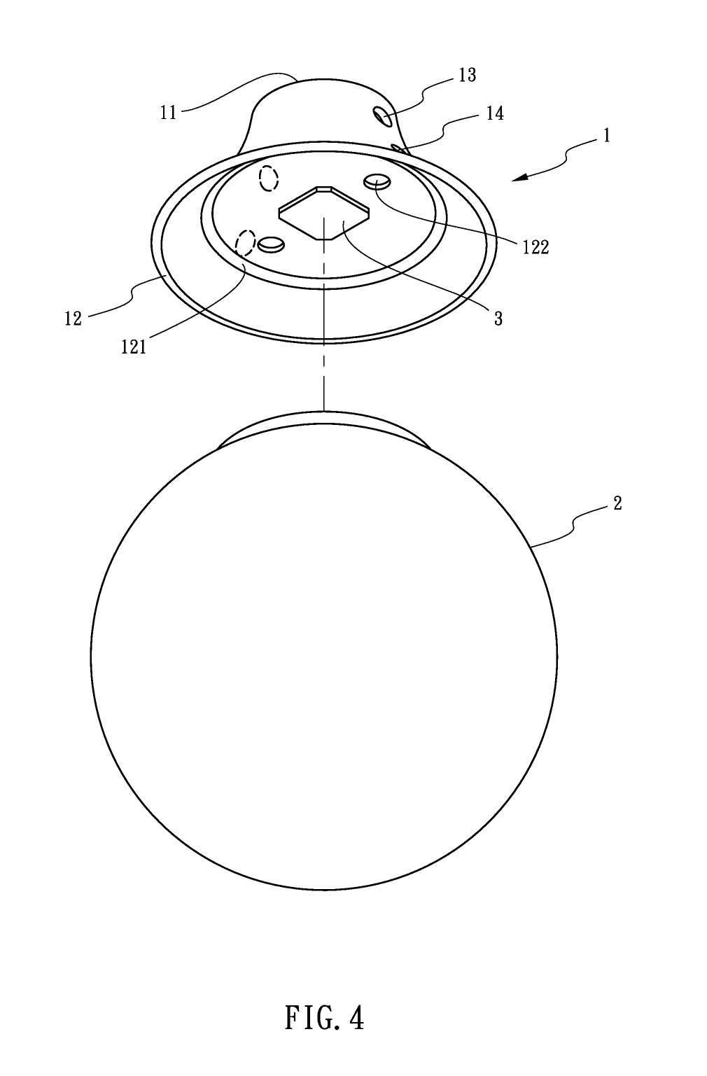

Referring to FIG. 4, the heat dissipating cover 1 comprises two first vents 13, two second vents 14, and two third vents 122 for the thermal convection.

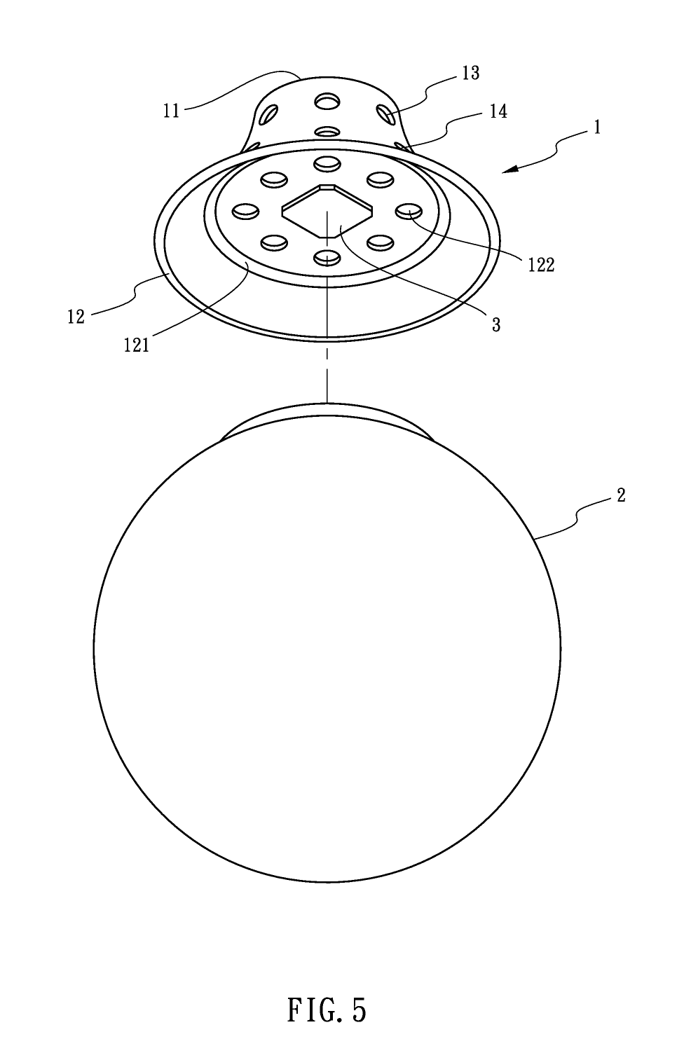

Referring to FIG. 5, the heat dissipating cover 1 comprises eight first vents 13, eight second vents 14, and eight third vents 122 for the thermal convection.

Thus, the heat from the light source 3 is not only transmitted into the air by the thermal conduction via the heat dissipating cover 1 and the glass shade 2, but also transmitted into the air by the thermal convection via the first vent 13, the second vent 14, and the third vent 122.

Although the invention has been explained in relation to its preferred embodiment, it is to be understood that many other possible modifications and variations can be made without departing from the spirit and scope of the invention as hereinafter claimed.

What is claimed is:

1. A heat dissipating device for lamps comprising:
a heat dissipating cover, the top side of the heat dissipating cover having a first opening defined thereon, the bottom side of the heat dissipating cover having a second opening defined thereon, the diameter of the first opening smaller than the diameter of the second opening, an annular recess with a base formed between the first opening and second opening, a light source assembled to the base of the annular recess;
a glass shade assembled to the second opening, the glass shade covering the light source; and
thereby the heat from the light source is dissipated into the air quickly because of the heat dissipating cover and the glass shade both with high thermal conductivity; the heat is not influenced on the light source for a long term use.

2. The heat dissipating device for lamps as claimed in claim 1, wherein the heat dissipating cover comprises at least one first vent and at least one second vent defined on the peripheral of the heat dissipating cover, the first vent close to the first opening, the second vent close to the second opening.

3. The heat dissipating device for lamps as claimed in claim 1, wherein the heat dissipating cover comprises at least one first vent or at least one second vent defined on the peripheral of the heat dissipating cover.

4. The heat dissipating device for lamps as claimed in claim 1, wherein the base of the annular recess has at least one third vent defined thereon.

5. The heat dissipating device for lamps as claimed in claim 1, wherein the third vent is near the light source.

6. The heat dissipating device for lamps as claimed in claim 1, wherein the heat dissipating cover comprises multiple first vents and multiple second vents defined on the peripheral of the heat dissipating cover, the first vents close to the first opening, the second vents close to the second opening, the base of the recess having multiple third vents defined thereon and near the light source.
